(19) United States
(12) Patent Application Publication
(10) Pub. No.: US 2008/0278872 A1
(43) Pub. Date: Nov. 13, 2008

(54) Electrostatic Discharge Protection Circuit

(75) Inventors: Zhao Wang, Beijing (CN); Hang Yin, Beijing (CN)

Correspondence Address: SILICON VALLEY PATENT AGENCY, 7394 WILDFLOWER WAY, CUPERTINO, CA, 95014, US

(73) Assignee: Vimicro Corporation

(21) Appl. No.: 12/017,279

(22) Filed: Jan. 21, 2008

(30) Foreign Application Priority Data
May 10, 2007 (CN) 200710099056.7

(51) Int. Cl. H02H 9/04

(52) U.S. Cl. 361/56

(57) ABSTRACT

Techniques pertaining to designs of ElectroStatic Discharge (ESD) protection circuits are disclosed. In one embodiment, an ESD protection circuit combines a substrate-driving technique with a gate-driving technique to ease the ESD design and save the silicon area. In another embodiment, an ESD protection circuit is based on a Positive Metal Oxide Semiconductor field effect transistor (PMOS) in a standard Complementary Metal Oxide Semiconductor (CMOS) process. In another embodiment, the ESD protection circuit is based on a negative Metal Oxide Semiconductor field effect transistor (NMOS) in the standard CMOS process. Depending on implementation, the ESD protection circuit is implemented for a negative voltage input pin, a normal input pin, and a power supply clamp circuit.

### BACKGROUND OF THE INVENTION

1. Field of the Invention

The present invention relates to the area of integrated circuit designs, more particularly to designs of an electrostatic discharge (ESD) protection circuit.

2. Description of Related Art

Electrostatic protection is important in the study of integrated circuits (IC). The ESD protection circuit is used to prevent chips from damage caused by static electricity, which often accompanies a large current and a large voltage.

Most of ESD protection schemes are designed to discharge via a ground pin, which is referred to as a ground-based ESD scheme. It is easy to employ an ESD device from every other pin to the ground pin. However, a conventional ESD device cannot be employed on a pin with negative voltage (called as “a negative voltage pin” hereafter) with reference to a ground because a parasitic P-N junction may be formed from a ground pin to the negative voltage pin. During a normal operation, the parasitic P-N junction may be forward-biased, thereby causing a leakage current which may result in failure or even damage of a chip. Even if the leakage current may be handled, the voltage of the negative voltage pin may be clamped to a forward-bias voltage −V_{F} of the parasitic P-N junction. Thus, applications of IC are restricted. Therefore, the ground-based ESD scheme is not applicable to the negative voltage pin.

AVDD-based ESD scheme may be adopted for the negative voltage pin. Most of VDD-based ESD schemes are based on a Positive Metal Oxide Semiconductor field effect transistor (PMOS) in standard CMOS (Complementary Metal Oxide Semiconductor) process. However, the PMOS cannot be triggered easily in a Negative Metal Oxide Semiconductor field effect transistor (NMOS) as a first stage ESD protection circuit. The NMOS has a parasitic NPN. During an ESD event, the P-N junction between the drain and the p-substrate of the NMOS is broken down first. Then, the base of the parasitic NPN may rise to a voltage supporting a forward bias on the P-N junction between the p-substrate and the source of the NMOS. As a result, the parasitic NPN is triggered to discharge the static electricity. But for the PMOS, the parasitic bipolar device is PNP. It is much more difficult to trigger the parasitic PNP because a current gain of the parasitic PNP is usually lower than the parasitic NPN for the same base width in standard CMOS process.

In the past, there are mainly two ways to improve a MOS ESD protection circuit, one is based on a gate-driving technique and the other is based on a substrate-driving technique. FIG. 1 shows an exemplary ESD protection circuit with the gate-driving technique for a negative voltage pin in the prior art, which is specifically disclosed in Chinese Patent No. CN 02131744.X. The ESD protection circuit shown in FIG. 1 is based on a PMOS. As described above, the PMOS does not have the parasitic NPN as the NMOS. It only has the parasitic PNP. As it is known, it is much more difficult to trigger the parasitic PNP in the PMOS than to trigger the parasitic NPN in the NMOS. Typically, the NPN gain is an order of magnitude higher than that of the PNP at low current levels so that turning on the NPN is easier to achieve than turning on the PNP. The gate-driving will improve the triggering of the PNP in some extent, it is not efficient to use gate-driving alone, especially for the negative-voltage input pin, because there is only one discharging path to VDD and no discharging path to GND.

FIG. 2 shows a substrate-driving ESD protection circuit with a general ESD detection circuit 62 in a prior art device. FIG. 3 shows a substrate-driving ESD protection circuit with a specific ESD detection circuit 66 in another prior art device. Comparing with the gate-driving, the substrate-driving may significantly improve ESD protection efficiency as described in the U.S. Pat. No. 6,566,715. It may be understood that the ESD level of a gate-driven NMOS is dramatically decreased when the gate voltage is over-increased. In experiments, a second breakdown current Iₜ₂ of the gate-driven NMOS drops suddenly when the gate bias is greater than 0.3V. Thus, the over-biased gate voltage may degrade the performance of the ESD protect of the gate-driven NMOS. Correspondingly, the second breakdown current Iₜ₂ increases as long as the bulk bias current increases for the substrate-driving.

However, the substrate-driving ESD protect circuit shown in FIG. 2 or FIG. 3 needs an extra detection circuit that has to increase the chip size. For a multi-pin chip, the increase could be accumulated. Furthermore, the substrate-driving ESD protect circuit shown in FIG. 2 and FIG. 3 needs a complex process to generate N-well for the ESD MOS, which increases the fabrication difficulty of the ESD protection circuit.

Thus, improved techniques for ESD protection circuit are desired to overcome at least some or all of the above mentioned disadvantages.

### SUMMARY OF THE INVENTION

This section is for the purpose of summarizing some aspects of the present invention and to briefly introduce some preferred embodiments. Simplifications or omissions in this section as well as in the abstract or the title of this description may be made to avoid obscuring the purpose of this section, the abstract and the title. Such simplifications or omissions are not intended to limit the scope of the present invention.

In general, the present invention is generally related to designs of ElectroStatic Discharge (ESD) protection circuits. According to one aspect of the present invention, an ESD protection circuit combines a substrate-driving technique with a gate-driving technique to ease the ESD design and save the silicon area. In one embodiment, an ESD protection circuit is based on a Positive Metal Oxide Semiconductor field effect transistor (PMOS) in a standard Complementary Metal Oxide Semiconductor (CMOS) process. In another embodiment, the ESD protection circuit is based on a negative Metal Oxide Semiconductor field effect transistor (NMOS) in the standard CMOS process. Depending on implementation, the ESD protection circuit is implemented for a negative voltage input pin, a normal input pin, and a power supply clamp circuit.

Other objects, features, and advantages of the present invention will become apparent upon examining the following detailed description of an embodiment thereof, taken in conjunction with the attached drawings.

### BRIEF DESCRIPTION OF THE DRAWINGS

These and other features, aspects, and advantages of the present invention will become better understood with regard to the following description, appended claims, and accompanying drawings where:

FIG. 1 shows an exemplary ESD protection circuit with gate-driving technique for a negative voltage pin in the prior art;

FIG. 2 shows a substrate-driving ESD protection circuit with a general ESD detection circuit in the prior art;

FIG. 3 shows a substrate-driving ESD protection circuit with a specific ESD detection circuit in the prior art;

FIG. 4 shows an exemplary ESD protection circuit for a negative voltage input pin according to one embodiment of the present invention.

FIG. 5 shows an exemplary ESD protection circuit for a negative voltage input pin according to another embodiment of the present invention;

FIG. 6 shows an exemplary ESD protection circuit for a normal input pin according to one embodiment of the present invention;

FIG. 7 shows an exemplary ESD protection circuit for a normal input pin according to another embodiment of the present invention;

FIG. 8 shows an exemplary ESD protection circuit for power supply clamp according to one embodiment of the present invention;

FIG. 9 shows an exemplary ESD protection circuit for power supply clamp according to another embodiment of the present invention; and

FIG. 10 is a schematic curve diagram of a bulk current response for an ESD pulse in one embodiment of the present invention.

### DETAILED DESCRIPTION OF THE INVENTION

The detailed description of the present invention is presented largely in terms of procedures, steps, logic blocks, processing, or other symbolic representations that directly or indirectly resemble the operations of devices or systems contemplated in the present invention. These descriptions and representations are typically used by those skilled in the art to most effectively convey the substance of their work to others skilled in the art.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of blocks in process flowcharts or diagrams or the use of sequence numbers representing one or more embodiments of the invention do not inherently indicate any particular order nor imply any limitations in the invention.

Embodiments of the present invention are discussed herein with reference to FIGS. 4-10. However, those skilled in the art will readily appreciate that the detailed description given herein with respect to these figures is for explanatory purposes only as the invention extends beyond these limited embodiments.

According to one embodiment of the present invention, an ESD protection circuit combines a substrate-driving technique with a gate-driving technique to ease the ESD design and save the silicon area. The ESD protection circuit according to the present invention is based on a Positive Metal Oxide Semiconductor field effect transistor (PMOS) in standard Complementary Metal Oxide Semiconductor (CMOS) process. The ESD protection circuit according to another embodiment of the present invention is based on a negative Metal Oxide Semiconductor field effect transistor (NMOS) in the standard CMOS process.

FIG. 4 shows an exemplary ESD protection circuit for a negative voltage input pin according to one embodiment of the present invention. The ESD protection circuit comprises resistors R1 and R2, a PMOS transistor MP in the standard CMOS process and a diode D. An integrated circuit shown in FIG. 4 which the ESD protection circuit is applied in includes a power supply pin VDD, a voltage input pin VM, a ground pin GND, an internal circuit and an ESD protection circuit from the power supply pin VDD to the ground pin GND. One terminal of the resistor R1 is electrically connected with a gate electrode of the PMOS transistor MP, and the other terminal of the resistor R1 is electrically connected to the power supply pin VDD. One terminal of the resistor R2 is electrically connected to the internal circuit, and the other terminal of the resistor R2 is electrically connected to the voltage input pin VM. A source electrode of the PMOS transistor MP is electrically connected to the power supply pin VDD, a drain electrode of the PMOS transistor MP is electrically connected to the voltage input pin VM, and a bulk electrode of the PMOS transistor is electrically interconnected with the gate electrode of the PMOS transistor. A positive electrode of the diode D is electrically connected to the voltage input pin VM, and a negative electrode of the diode D is electrically connected to the power supply pin VDD.

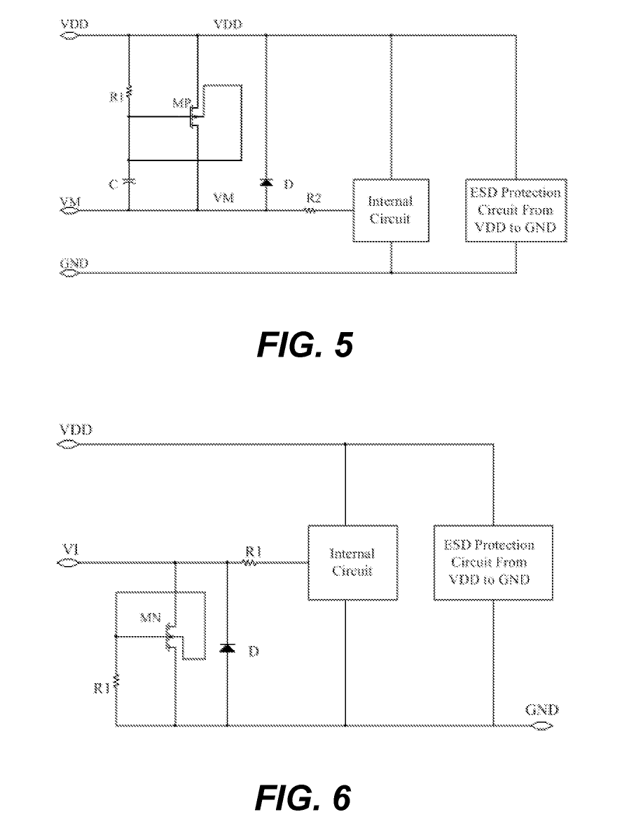

In a case, the voltage input pin VM may be designed for inputting a negative voltage. In other cases, the voltage input pin VM may also be designed for inputting a positive voltage. The ESD protection circuit from the VDD to the GND may be identical with the ESD protection circuit of the present invention shown in FIG. 4 or may be identical with one of the ESD protection circuits of the present invention shown in FIGS. 5-7 to be described hereafter.

The ESD protection circuit of the present invention shown in FIG. 4 takes advantage of the substrate-driving technique and the gating-driving technique. It may be much more efficient during an ESD event. Either a positive ESD pulse or a negative ESD pulse may happen between any two pins, the static electricity can be discharged safely by the ESD protection circuit.

When the ESD positive pulse from the VM to the VDD happens, the voltage of the VM is higher than that of the VDD and then the static electricity is discharged through the forward-biased diode D. When the ESD negative pulse from the VM to the VDD happens, the voltage of the VM is lower than that of the VDD and then the static electricity is discharged through breakdown of the MP. When the ESD positive pulse from the VM to the GND happens, the static electricity is discharged through the forward-biased diode D and breakdown of the ESD protection circuit from the VDD to the GND. When the ESD negative pulse from the VM to the GND happens, the static electricity is discharged through the forward-biased parasitic diode of the ESD protection circuit from the VDD to the GND and breakdown of the MP.

The resistor R2 serves as a second stage ESD protection circuit to restrict a current flowing into the internal circuit. If an input terminal of the internal circuit is the gate electrode of MOS, a reversed diode is required to be connected between the gate electrode of MOS and the GND to prevent from a quick ESD pulse during testing a CDM (Charged Device Model).

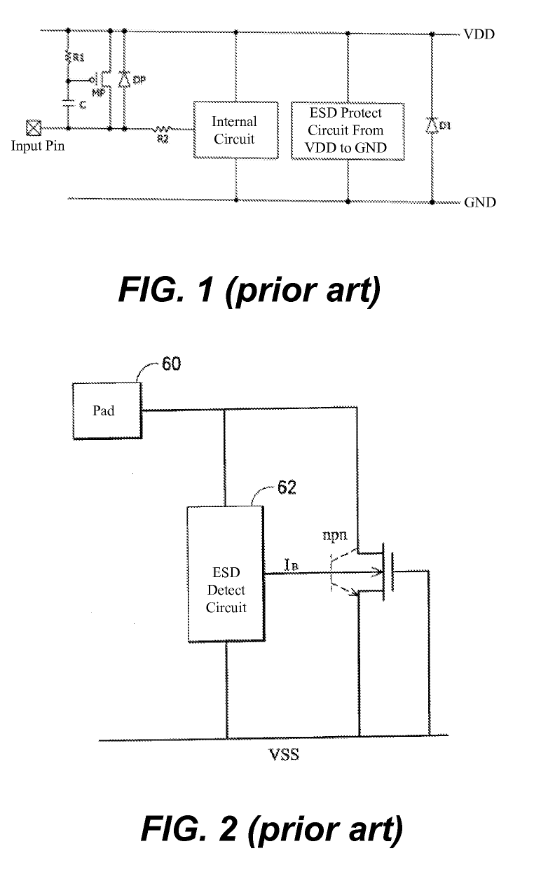

The breakdown principle of the MP shown in FIG. 4 is described in detail for further understanding the present invention. As similar to the gate-driving shown in FIG. 1, the substrate of the MP is coupled to be lower than the VDD and approximate to the VM due to big capacitance of a parasitic capacitor Cgd formed between the gate electrode and the drain electrode of the MP when one negative ESD pulse from the VM to the VDD comes. Then, a bulk bias current flows out of the bulk electrode of the MP. The bulk bias current flows through a body resistance of the MP to form a voltage drop on it. If the voltage drop is greater than a forward bias voltage V_{BE} of the parasitic PNP of the MP, the parasitic PNP is triggered to discharge the static electricity.

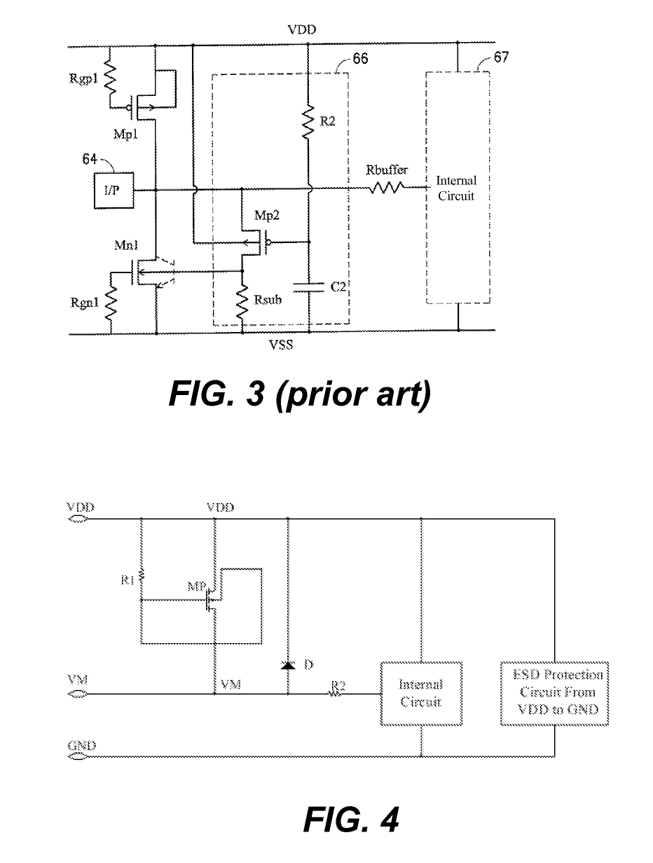

So comparing with the ESD protection circuit with only gate-driving and the same size, the ESD protection circuit of the present invention has a larger second breakdown current Iₜ₂, thereby providing a more efficient performance for the ESD protection. Comparing with the ESD protection circuit with the substrate driving shown in FIG. 3, the complex detection circuit is removed from the ESD protection circuit of the present invention. Furthermore, the ESD protection circuit of the present invention doesn't need a complex process to generate an n-well for the ESD MOS shown in FIG. 3. Main benefit of the N-well is to increase bulk resistance of ESD MOS. In this invention, the similar effect can be obtained by increasing resistance of the resistor R1.

FIG. 5 shows an exemplary ESD protection circuit for a negative voltage input pin according to one embodiment of the present invention. The ESD protection circuit according to the second embodiment shown in FIG. 5 can be obtained by adding a capacitor C between the gate electrode of the MP and the VM shown in FIG. 4. It should be noted that the voltage input pin VM shown in FIG. 5 may be designed for inputting a negative voltage or a positive voltage.

The addition of the capacitor C help to increase a coupling voltage between the drain electrode and the gate electrode of the MP during electrostatic discharge as a conventional capacitor C shown in FIG. 1. On the other hand, the capacitor C requires to be charged firstly and then a part of charging current flows out of the bulk electrode of the MP when a quick ESD pulse from the VDD to the VM happens. Thus, the current flowing out of the bulk electrode of the MP is increased to further enhance ESD discharge capacity of the MP.

When the ESD event occurs, the ESD protection circuit according to the second embodiment performs same operations as the ESD protection circuit according to the first embodiment except that the added capacitor C can further enhance the ESD discharge capacity of the MP. Hence, the corresponding description is abbreviated hereafter for simplicity.

When the ESD positive pulse from the VM to the VDD happens, the voltage of the VM is higher than that of the VDD and then the static electricity is discharged through the forward-biased diode D. When the ESD negative pulse from the VM to the VDD happens, the voltage of the VM is lower than that of the VDD and then the static electricity is discharged through breakdown of the MP with the gate-driving and substrate-driving. When the ESD positive pulse from the VM to the GND happens, the static electricity is discharged through the forward-biased diode D and breakdown of the ESD protection circuit from the VDD to the GND. When the ESD negative pulse from the VM to the GND happens, the static electricity is discharged through the forward-biased parasitic diode of the ESD protection circuit from the VDD to the GND, and breakdown of the MP.

FIG. 6 shows an exemplary ESD protection circuit for a normal input pin according to one embodiment of the present invention. The ESD protection circuit comprises resistors R1 and R2, a NMOS transistor MN in standard CMOS process and a diode D. An integrated circuit shown in FIG. 6 which the ESD protection circuit is applied in includes a power supply pin VDD, a voltage input pin VI, a ground pin GND, an internal circuit and an ESD protection circuit from the power supply pin VDD to the ground pin GND. One terminal of the resistor R1 is electrically connected with a gate electrode of the NMOS transistor MN, and the other terminal of the resistor R1 is electrically connected to the ground pin GND. One terminal of the resistor R2 is electrically connected to the internal circuit, and the other terminal of the resistor R2 is electrically connected to the voltage input pin VI. A source electrode of the NMOS transistor MP is electrically connected to the ground pin GND, a drain electrode of the NMOS transistor MN is electrically connected to the voltage input pin VI, and a bulk electrode of the NMOS transistor is electrically interconnected with the gate electrode of the NMOS transistor. A positive electrode of the diode D is electrically connected to the ground pin GND, and a negative electrode of the diode D is electrically connected to the voltage input pin VI. In a case, the voltage input pin VI may be designed for inputting a positive voltage.

When the ESD positive pulse from the VI to the GND happens, the static electricity is discharged through breakdown of the MN with the gate-driving and substrate-driving. When the ESD negative pulse from the VI to the GND happens, the static electricity is discharged through the forward-biased diode D. When the ESD positive pulse from the VI to the VDD happens, the static electricity is discharged through the forward-biased parasitic diode of the ESD protection circuit from the VDD to the GND and breakdown of the MN. When the ESD negative pulse from the VI to the VDD happens, the static electricity is discharged through the forward-biased diode D and breakdown of the ESD protection circuit from the VDD to the GND.

The resistor R2 serves as a second stage ESD protection circuit to restrict a current flowing into the internal circuit. If an input terminal of the internal circuit is the gate electrode of MOS, a reversed diode is required to be connected between the gate electrode of MOS and the GND to prevent from a quick ESD pulse during testing a CDM (Charged Device Model).

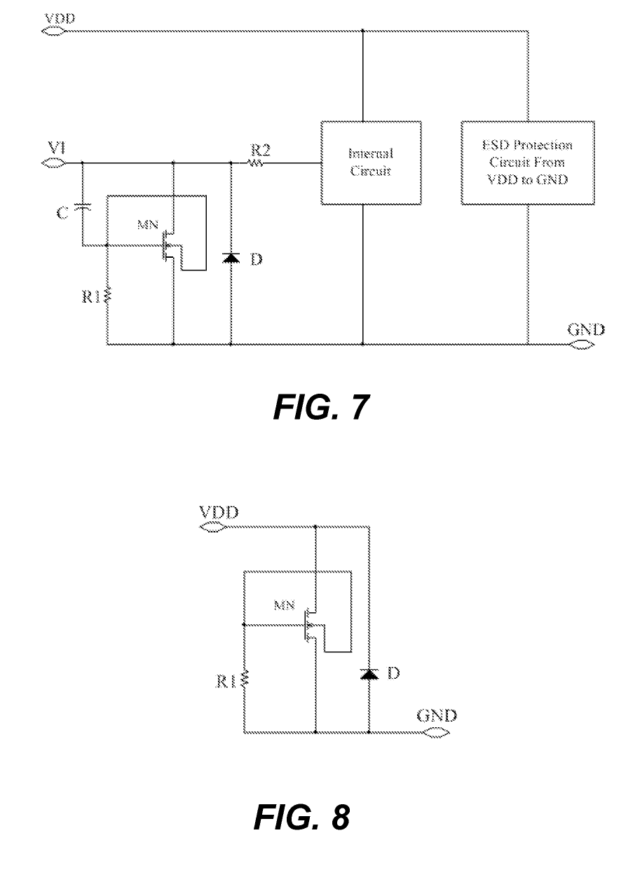

The breakdown principle of the MN shown in FIG. 6 is similar to that of the MP shown in FIG. 4. So the corresponding description is omitted here. FIG. 7 shows an exemplary ESD protection circuit for a normal input pin according to the fourth embodiment of the present invention. The ESD protection circuit according to one embodiment shown in FIG. 7 can be obtained by adding a capacitor C between the gate electrode of the MN and the VI shown in FIG. 6. It should be noted that the voltage input pin VI shown in FIG. 7 may be designed for inputting a positive voltage.

When the ESD event occurs, the ESD protection circuit according to the embodiment performs same operations as the ESD protection circuit according to the third embodiment except that the added capacitor C can further enhance the ESD discharge capacity of the MN as same as the added capacitor C in the second embodiment.

When the ESD positive pulse from the VI to the GND happens, the static electricity is discharged through breakdown of the MN. When the ESD negative pulse from the VI to the GND happens, the static electricity is discharged through the forward-biased diode D. When the ESD positive pulse from the VI to the VDD happens, the static electricity is discharged through the forward-biased parasitic diode of the ESD protection circuit from the VDD to the GND and breakdown of the MN. When the ESD negative pulse from the VI to the VDD happens, the static electricity is discharged through the forward-biased diode D and breakdown of the ESD protection circuit from the VDD to the GND.

FIG. 8 shows an exemplary ESD protection circuit for power supply clamp according to one embodiment of the present invention. The ESD protection circuit comprises a resistor R1, a NMOS transistor MN in standard CMOS process and a diode D. One terminal of the resistor R1 is electrically connected with a gate electrode of the NMOS transistor MN, and the other terminal of the resistor R1 is electrically connected to the ground pin GND. A source electrode of the NMOS transistor MP is electrically connected to the ground pin GND, a drain electrode of the NMOS transistor MN is electrically connected to the power supply pin VDD, and a bulk electrode of the NMOS transistor is electrically interconnected with the gate electrode of the NMOS transistor. A positive electrode of the diode D is electrically connected to the ground pin GND, and a negative electrode of the diode D is electrically connected to the power supply pin VDD.

When the ESD positive pulse from the VDD to the GND happens, the static electricity is discharged through breakdown of the MN. When the ESD negative pulse from the VDD to the GND happens, the static electricity is discharged through the forward-biased diode D.

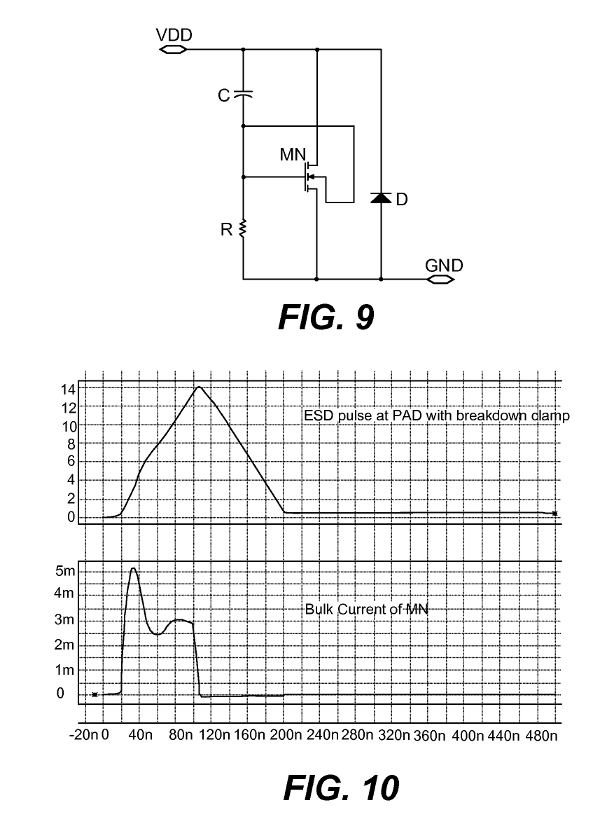

FIG. 9 shows another exemplary ESD protection circuit for power supply clamp according to one embodiment of the present invention. The ESD protection circuit according to the sixth embodiment shown in FIG. 9 can be obtained by adding a capacitor C between the gate electrode of the MN and the VDD of the ESD protection circuit according to the embodiment shown in FIG. 8.

When the ESD positive pulse from the VDD to the GND happens, the static electricity is discharged through breakdown of the MN. When the ESD negative pulse from the VDD to the GND happens, the static electricity is discharged through the forward-biased diode D. When the MN is broken down reversely, the capacitor C can help to increase the current flowing out of the bulk electrode of the MN, thereby enhancing the ESD discharge capacity of the MN.

For the ESD protection circuit shown in FIG. 9, for example, if C=20 pF, R=30KΩ, MN's dimension is L=1U W=20U M=20, the ESD pulse is hundreds of ns width and a device breakdown voltage is around 14 volts. We can obtain a bulk current response for the ESD pulse as following FIG. 10. The bulk current will ramp up to 3˜5 mA. Additionally, the bulk current will increase the second breakdown current Iₜ₂. As a consequence, the ESD level is increased.

As a result, the ESD protection circuit of the present invention can remove the complex detection circuit therefrom only by changing the electrode connection of the PMOS or NMOS thereof. Additionally, the ESD protection circuit of the present invention doesn't need a complex process to generate an n-well for the ESD MOS shown in FIG. 3. Correspondingly, the same effect can be obtained by increasing resistance of the resistor R1. It will ease the ESD design and save area.

The present invention has been described in sufficient details with a certain degree of particularity. It is understood to those skilled in the art that the present disclosure of embodiments has been made by way of examples only and that numerous changes in the arrangement and combination of parts may be resorted without departing from the spirit and scope of the invention as claimed. Accordingly, the scope of the present invention is defined by the appended claims rather than the foregoing description of embodiments.

What is claimed is:

1. An ESD protection circuit comprising:
a PMOS transistor having a gate electrode, a source electrode, a drain electrode and a bulk electrode, the drain electrode of the PMOS transistor being connected with a first node and the source electrode of the PMOS transistor is connected with a second node; and
a resistor with one terminal thereof connecting with the second node and the other terminal thereof connecting with the gate electrode of the PMOS transistor, wherein the bulk electrode of the PMOS transistor is interconnected with the gate electrode of the PMOS transistor.

2. The ESD protection circuit according to claim 1, further comprising a diode having a positive electrode connecting with the first node and a negative electrode connecting with the second node.

3. The ESD protection circuit according to claim 1, further comprising a capacitor being connected in serials between the first node and the gate electrode of the PMOS transistor.

4. The ESD protection circuit according to claim 1, wherein the PMOS transistor is fabricated according to a standard CMOS process.

5. The ESD protection circuit according to claim 1, wherein the first node is a voltage input pin or a ground input pin and the second node is a power supply pin.

6. The ESD protection circuit according to claim 5, wherein the voltage input pin is designed for inputting a negative voltage.

7. The ESD protection circuit according to claim 1, further comprising another resistor with one terminal thereof connecting with the first node and the other terminal thereof connecting to an internal circuit.

8. The ESD protection circuit according to claim 7, wherein an input terminal of the internal circuit is a gate electrode of MOS, and a reversed diode is connected between the gate electrode of MOS and a ground pin.

9. An ESD protection circuit comprising:
a NMOS transistor having a gate electrode, a source electrode, a drain electrode and a bulk electrode, the drain electrode of the NMOS transistor being connected with a first node and the source electrode of the PMOS transistor is connected with a second node; and
a resistor with one terminal thereof connecting with the second node and the other terminal thereof connecting with the gate electrode of the NMOS transistor, wherein the bulk electrode of the NMOS transistor is interconnected with the gate electrode of the NMOS transistor.

10. The ESD protection circuit according to claim 9, further comprising a diode having a positive electrode connecting with the second node and a negative electrode connecting with the first node.

11. The ESD protection circuit according to claim 9, further comprising a capacitor being connected in serials between the first node and the gate electrode of the NMOS transistor.

12. The ESD protection circuit according to claim 9, wherein the NMOS transistor is fabricated according to a standard CMOS process.

13. The ESD protection circuit according to claim 9, wherein the first node is a power supply pin or a voltage input pin and the second node is a ground pin.

14. The ESD protection circuit according to claim 9, further comprising another resistor with one terminal thereof connecting with the first node and the other terminal thereof connecting to an internal circuit.

15. The ESD protection circuit according to claim 9, wherein an input terminal of the internal circuit is a gate electrode of MOS, and a reversed diode is connected between the gate electrode of MOS and a ground pin.

16. An integrated circuit comprising:
a power supply pin, a ground pin and a voltage input pin;
an internal circuit having one terminal connecting with the power supply pin, the other terminal connecting with the ground pin and another terminal connecting with the voltage input pin via a resistor;
an ESD protection circuit configured between any two pins of the power supply pin, the ground pin and the voltage input pin, the ESD protection circuit comprising:
a MOS transistor having a gate electrode, a source electrode, a drain electrode and a bulk electrode, the drain electrode of the PMOS transistor being connected with one of the any two pins and the source electrode of the PMOS transistor is connected with the other of the any two pins;
a resistor with one terminal thereof connecting with the other of the any two pins and the other terminal thereof connecting with the gate electrode of the MOS transistor; wherein the bulk electrode of the MOS transistor is interconnected with the gate electrode of the MOS transistor.

17. The integrated circuit according to claim 16, wherein the MOS transistor is a PMOS transistor, and wherein the ESD protection circuit further comprises a diode having a positive electrode connecting with the one of the any two pins and a negative electrode connecting with the other of the any two pins.

18. The integrated circuit according to claim 16, wherein the MOS transistor is a NMOS transistor, and wherein the ESD protection circuit further comprises a diode having a positive electrode connecting with the other of the any two pins and a negative electrode connecting with the one of the any two pins.

19. The integrated circuit according to claim 16, wherein the ESD protection circuit further comprises a capacitor being connected in serials between the one of the any two pins and the gate electrode of the MOS transistor.
